(19) United States
(12) Patent Application Publication
(10) Pub. No.: US 2023/0368082 A1
(43) Pub. Date: Nov. 16, 2023

(54) Amusement Venue Entry Control System and Method

(71) Applicant: Isaiah Bitah, Church Rock, NM (US)

(72) Inventor: Isaiah Bitah, church rock, NM (US)

(21) Appl. No.: 17/743,683

(22) Filed: May 13, 2022

(51) Int. Cl. G06Q 10/02

(52) U.S. Cl. CPC G06Q 10/02

(57) ABSTRACT

The present invention in some embodiments thereof, generally relates to a system, apparatus and method for controlling entry into an amusement venue such as a laser tag venue or any such. According to on embodiment, a portable computing device is provided to a person, the device being configured to perform a venue entry reservation on a time slot database, wherein a digital token may be used to reserve entry into the time slot, and a visual code generated, wherein the code is associated to the person's identifier in a database, and the reserved time slot. According to another embodiment, a scanner may be provided at the amusement venue entry to scan the generated visual code, determine the allotted time slot and grant entry to the user at the allotted time slot.

### FIELD OF INVENTION

The present invention in some embodiments thereof, generally relates to a system apparatus and method of controlling entry into an amusement venue.

### RELATED APPLICATIONS

An amusement park or venue is a park that features various attractions, such as rides and games, as well as other events for entertainment purposes. A laser tag venue is one such venue. Controlling the entry into such venues is important as it can speed up the process and allow more time into playing games and enjoying the facility.

To be an effective vessel, the physical location of a venue including accessibility for travelers, nearby attractions and restaurants, and a variety of accommodations is essential. Attendee comfort is crucial. A venue should provide adequate space and facilities for your group so having a realistic anticipated attendance number is imperative. On the aspect of controlling entry, online ticketing systems have been used by many amusement venues.

A ticketing system is a software platform designed to capture customer service requests and help your business manage that request all the way to resolution. Ticketing systems are ideal for service environments that have constant changes in the flow of work. IT and customer service teams commonly use a ticketing system to manage workflow. For amusement venues, the ticketing system is most often used in conjunction with the service desk. The service desk serves as a piece of the information technology infrastructure Library which is a set of IT best practices. As part of the ITIL processes, the service desk technicians use IT management software to improve the delivery of IT services to their customers. Most platforms available on the market today are cloud-based help desk software. This works well especially for remote IT management because it reduces costs and complexity.

This kind of ticketing system may require a printed receipt, a wristband or such to enter a venue. These could be forged, take a lot of time to process at the entrance, and generally, the tickets must be validated at the entrance.

However, all discussed prior art does not disclose a system, apparatus, and method for controlling entry into an amusement venue such as a laser tag venue or any such. It is there for an object of the current invention to overcome the technical limitation identified in the prior art.

### SUMMARY OF THE INVENTION

The following summary is an explanation of some of the general inventive steps for the device, method, and construction in the description. This summary is not an extensive overview of the invention and does not intend to limit the scope beyond what is described and claimed as a summary.

The present invention in some embodiments thereof, generally relates to a system, apparatus, and method for controlling entry into an amusement venue such as a laser tag venue or any such. According to on embodiment, a portable computing device is provided to a person, the device being configured to perform a venue entry reservation on a time slot database, wherein a digital token may be used to reserve entry into the time slot, and a visual code generated, wherein the code is associated to the person's identifier in a database, and the reserved time slot. According to another embodiment, a scanner may be provided at the amusement venue entry to scan the generated visual code, determine the allotted time slot, and grant entry to the user at the allotted time slot. According to one embodiment, a scanner is provided at the entrance to scan the visual code and determined the customer and time slot for which it was generated. Hardware compatibility includes shelf scanner like GSM 4G Handheld Computer device Android 8.1 Barcode Scanner 1D 2D NFC RFID Reader PDA with Pistol Grip and hard compatibility also includes custom made scanners. According to one embodiment, the scanner may be installed at the facility to automatically scan the generated codes and grant entry. According to one embodiment, entry may only be granted at the allotted time slot. According to one embodiment Validation methods update includes NFC communication, 1D barcode, 125K reader, UHF reader, Bluetooth, WIFI, Auditory. According to one embodiment, the invention compatible payment methods includes credit card, debit card and Crypto currency.

### BRIEF DESCRIPTION OF THE FIGURES

FIG. 1 of the diagrams illustrates an exemplary database system according to one embodiment.

FIG. 2 of the diagrams illustrates an exemplary system according to one embodiment.

### DETAILED DESCRIPTION OF THE INVENTION

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms to describe the invention in the best way.

It is to be understood that the form of the invention shown and described herein is to be taken as a preferred embodiment of the present invention, so it does not express the technical spirit and scope of this invention. Accordingly, various changes and modifications may be made to the invention without departing from the spirit and scope thereof.

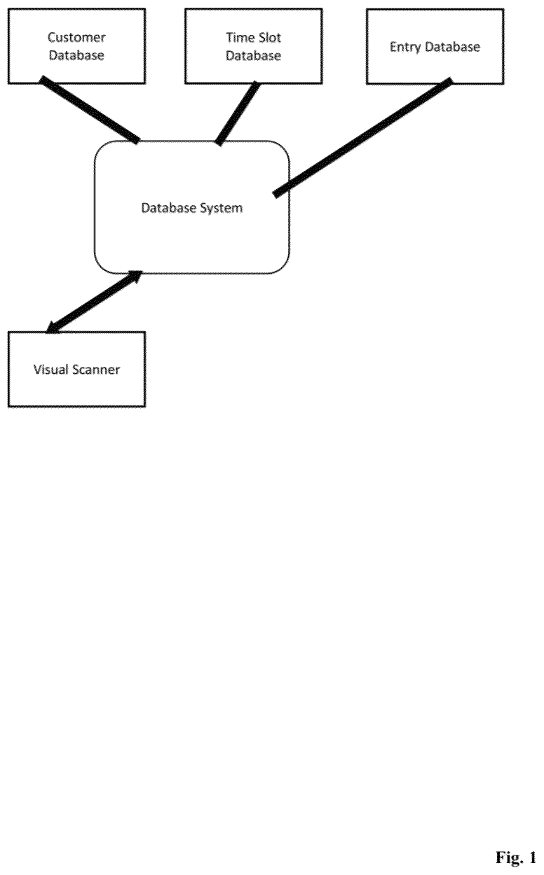

In the first embodiment according to FIG. 1 of the diagram illustrates an exemplary database system according to one embodiment. This database is configured to store customer information, whereby customers may be registered into the database using any such suitable means.

Once registered, each user is assigned a unique identifier, which may be identifiable to them and their activities in the system. For example, the customer/user identifier may be associated with Customer Name, Age, Payment methods, Credits, Account Status, Etc. The user may have credits or in-house tokens associated with their unique identifier.

Further, the database comprises a time slot management database. A time slot chain is provided in this database capable of updating the time slots with unique customer identifiers for the allotted time slots. There may be provided a suitable computer program to place users into the time slot database and enable the purchase of time slots using a digital token or in-house currency. It may further be provided an entry database, which shows what users are registered at what time slot and for what games at the venue. The entry database is preferably updated in real time and the information provided to all other users. It is also updated when time slot allocations expire, when time passes and when they are utilized. The entry database comprises both the allocated time slot and the unique user identifier, which may be encoded in any such suitable format including QR codes, bar codes, among others. A scanner at the venue may thus be capable of scanning a provided encoded identifier, refer to the entry database and determine both the user and time slot for using the venue.

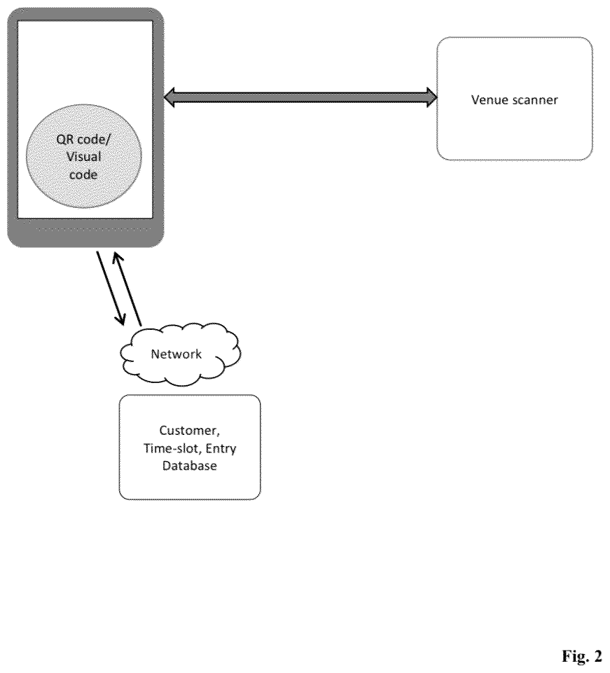

FIG. 2 of the diagrams illustrates an exemplary system according to one embodiment. The disclosed system, apparatus and method are shown as could be installed for entry into an amusement venue such as a laser tag venue or any such. In the figure, it is shown a portable computing device is provided to a person, the device being configured to perform a venue entry reservation on a time slot database described in FIG. 1 above. This device could be a smartphone, laptop, a wearable computing device or any such. A digital token, such as an in-house currency may be used to reserve time at the venue to engage in the amusement, which may be a laser tagging activity or any such. In this embodiment, a digital token may be used to reserve entry into the time slot, and a visual code generated. The visual code could be a QR code, any encoded digit or symbol. This generated code is associated to the person's identifier in a database, and the reserved time slot. At the venue, a scanner may be provided at the entry to scan the generated visual code, determine the allotted time slot, and grant entry to the user at the allotted time slot. The person may then be granted access to the venue at the allotted time slot.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

### INDUSTRIAL APPLICATION

The invention is applicable in the venue entry control systems

What is claimed is:

1. An amusement venue entry control system comprising:
a scanner at the venue;
a database comprising user database, entry database and time slotting database, wherein, a code is generated for a user in the allotted time slot in the database, wherein said code enables entry into the venue.

2. The venue entry control system of claim 1, wherein a scanner is provided at the entrance to scan the visual code and determined the customer and time slot for which it was generated.

3. The venue entry control system of claim 1, wherein the scanner may be installed at the facility to automatically scan the generated codes and grant entry.

4. The venue entry control system of claim 1, wherein entry may only be granted at the allotted time slot
